(19) United States
(12) Patent Application Publication
(10) Pub. No.: US 2004/0190701 A1
(43) Pub. Date: Sep. 30, 2004

(54) Apparatus and method for a distributed conference bridge

(75) Inventor: Daniel Biage, Hull (CA)

Correspondence Address: MILES & STOCKBRIDGE PC, 1751 PINNACLE DRIVE, SUITE 500, MCLEAN, VA, 22102-3833, US

(73) Assignee: Versatel Networks Inc.

(21) Appl. No.: 10/400,414

(22) Filed: Mar. 28, 2003

(51) Int. Cl. H04M 3/42

(52) U.S. Cl. 379/202.01

(57) ABSTRACT

An apparatus and a method for a distributed conference bridge having a plurality of interface modules, each with voice signal bridging capability, connected by a bus. The present invention reduces the voice signal bandwidth requirement for the bus and increases the reliability of the conference bridge compared to a centralized conference bridge. An embodiment with conference participants connected to a second bus reduces the bandwidth requirement between the buses compared to a centralized conference bridge with participants connected to an auxiliary chassis.

### FIELD OF INVENTION

The present invention relates to the field of telephony conferencing. In particular, to an apparatus and a method for a distributed voice conference bridge.

### BACKGROUND

In the delivery of telephony services it is well known to provide support for multi-party (more than two participants) calls often referred to as conference calls. In general, the equipment used in delivering common two party calls does not lend itself to supporting multi-party calls by the simple interconnection of the multiple connections (lines) involved. In order to address needs such as echo cancellation, audio level matching/adjustment and other similar needs a conference bridge is typically used to interconnect the participants in a conference call.

A typical conference bridge 100A as known in the prior art is represented in FIG. 1. This conference bridge 100A comprises a plurality of interface units 120A-C connected via a bus 110A to a bridging unit 130. Participant voice signals received from terminal devices 140A-C by each of interface units 120A-C respectively are sent via the bus 110A to the bridging unit 130. The bridging unit 130 applies one of a number of well-know conference algorithms to generate a specific net conference signal for each participant. Each of the net conference signals, specific to a participant, is sent via the bus 110A to the interface units 120A-C and then to the terminal devices 140A-C respectively associated with each of the participants. This approach can be said to use a centralized conference bridge.

In FIGS. 1-2 the arrows connecting the elements indicate the flow of signals. The annotations beside the arrows identify exemplary signals in a conference call scenario. Signal A is received from terminal device 140A by interface unit 120A, is provided to bus 110A and then to bridging unit 130. Similarly signals B and C from terminal devices 140B and 140C are provided to bridging unit 130. Net conference signal B+C is generated by bridging unit 130 and is provided, via bus 110A, to interface unit 120A and onto terminal device 140A. Similarly, signal A+C and A+B are generated by the bridging unit 130 and provided to interface units 120B and 120C and then onto terminal devices 140B and 140C respectively.

Using the centralized conference bridge approach of the typical conference bridge 100A, it can be seen that in order to provide a conference call with three participants sufficient bandwidth must be provided in bus 110A to support at least six concurrent signals (i.e.: A, B, C, B+C, A+C and A+B). Generalizing this requirement, for N participants bandwidth for at least 2*N signals is required in the bus 110A.

Similarly, for a conference call with three participants the bridging unit 130 must have sufficient throughput to generate three net conference signals (e.g. B+C, A+C, A+B), each having at least two contributing signals, with insignificant time delay. Insignificant time delay means with minimal audible distortion being perceived by a human listener (a participant). Generalizing, for N participants the bridging unit 130 needs sufficient throughput to generate N net conference signals concurrently, each with at least N−1 contributing signals, with insignificant time delay.

As a result of the above requirements, scaling up of centralized conference bridge capacity can be costly. Typically, conference bridges are engineered and built to support a specific maximum number of participants (often designated by a ‘number of ports’ supported) to enable optimization of the implementation. An unfortunate by-product of this approach is frequent sub-optimal use of conference bridges. Conferences bridges are usually configured for the maximum number of participants (e.g. N) anticipated for a conference call. However, for a conference call with any number of participants less than N, the unused ports, and the associated bus and bridging unit capacities, in a given conference call are unavailable for other use. The conference bridge is effectively ‘entirely’ consumed.

In instances where some of the participants in a conference call are relatively far from the conference bridge, another conventional architecture as represented in FIG. 2 is known to apply. In addition to a conference bridge 110B, similar to the conference bridge 100A of FIG. 1 with the addition of a remote interface unit 160A, there is also an auxiliary chassis 105. The conference bridge 100B and the auxiliary chassis 105 are separated from one and other by, for example, being geographically remote. The auxiliary chassis 105 has interface units 120D-E connected to terminal devices 140D and 140E respectively, a bus 110B and a remote interface unit 160B. The remote interface units 160A and 160B enable signals to be sent between the conference bridge 100B and the auxiliary chassis 105. Signals D and E from the terminal devices connected to the auxiliary chassis are sent to the bridging unit and net conference signals A+B+C+E and A+B+C+D are generated and sent back in a manner similar to the treatment of the signals A,B,C from the terminal devices connected to the conference bridge 100B. Other aspects of conference call operation are similar to operation of the conference bridge 100A of FIG. 1. As can be seen on inspection of FIG. 2, the number of signals flowing from the auxiliary chassis 105 to the conference unit 100B, via remote interface units 160A and 160B, is two. The number of signals flowing from the conference unit 100B to the auxiliary chassis 105 is also two. Generalizing, the number of signals flowing from the remote chassis to the conference bridge and number of signals flowing in the opposite direction is each equal to the number of participants connected to the auxiliary chassis. Therefore, for R conference participants connected to the auxiliary chassis there must be at least sufficient bandwidth for 2*R concurrent signals between the remote interface units 160A and 160B.

As can be understood from the above, the resource requirement of centralized conference bridges and of remote configurations of these conference bridges make scaling up the capacity of the conference bridges relatively expensive. A less resource intensive, and therefore less costly, approach to conference bridge capacity scaling is required.

The centralized conference bridge also is susceptible to single point of failure and single point of congestion on the bridging unit 130. A more robust and tolerant approach would reduce the risk of failure or congestion by distributing the bridging unit functionality over a broader base.

### SUMMARY OF INVENTION

In accordance with one aspect of the present invention, a distributed conference bridge comprising: a bus, having a plurality of ports, for providing a participant voice signal received at one of said plurality of ports to all other of said plurality of ports; and a plurality of interface modules, each for connecting to said bus via one of said plurality of ports, each having a line interlace for receiving a participant voice signal and for providing a net conference voice signal; a bus interface for providing said participant voice signal to said bus and for receiving from said bus other participant voice signals; a signal bridging mechanism for generating said net conference voice signal from said other participant voice signals.

In accordance with another aspect of the present invention, an interface module for use in a distributed conference bridge comprising a bus, having a plurality of ports, for providing a voice signal received at one of said plurality of ports to all other of said plurality of ports and a plurality of interface modules, according to said interface module and including said interface module, each for connecting to said bus via one of said plurality of ports, said interface module comprising: a line interface for receiving a participant voice signal and for providing a net conference voice signal; a bus interface for providing said participant voice signal to said bus and for receiving from said bus other participant voice signals; and a signal bridging mechanism for generating said net conference voice signal from said other participant voice signals.

In accordance with still another aspect of the present invention, a method for operation of a distributed conference bridge having a plurality of interface modules each receiving a voice signal from and providing a net conference signal to a participant from a plurality of conference call participants, for each of the interface modules the method comprising the steps of: a) receiving the voice signal from the participant; b) providing the voice signal to each of the others of the plurality of interface modules; c)receiving a plurality of voice signals provided in step b) by the others of the plurality of interface modules; d) summing together the voice signal and the plurality of voice signals to generate a total voice signal; e) subtracting the voice signal from the total voice signal to generate a net conference signal; and f) providing the net conference signal to the participant.

In accordance with yet another aspect of the present invention, 6. A computer program product for operation of a distributed conference bridge having a plurality of interface modules each receiving a voice signal from and providing a net conference signal to a participant from a plurality of conference call participants, the computer program product comprising: computer readable program code devices for: a) receiving the voice signal from the participant; b) providing, the voice signal to each of the others of the plurality of interface modules; c) receiving a plurality of voice signals provided in step b) by the others of the plurality of interface modules; d) summing together the voice signal and the plurality of voice signals to generate a total voice signal; e) subtracting the voice signal from the total voice signal to generate a net conference signal; and f) providing the net conference signal to the participant.

In accordance with yet still another aspect of the present invention, a method for operation of a distributed conference bridge having a plurality of interface modules each receiving a voice signal from and providing a net conference signal to a participant from a plurality of conference call participants, for each of the interface modules the method comprising the steps of: a) receiving the voice signal from the participant; b) providing the voice signal to each of the others of the plurality of interface modules; c) receiving a plurality of voice signals provided in step b) by the others of the plurality of interface modules; d) summing together the plurality of voice signals to generate a net voice signal; and e) providing the net conference signal to the participant.

In accordance with a further aspect of the present invention, a computer program product for operation of a distributed conference bridge having a plurality of interface modules each receiving a voice signal from and providing a net conference signal to a participant from a plurality of conference call participants, the computer program product comprising: computer readable program code devices for: a) receiving the voice signal from the participant; b) providing the voice signal to each of the others of the plurality of interface modules; c) receiving a plurality of voice signals provided in step b) by the others of the plurality of interface modules; d) summing together the plurality of voice signals to generate a net voice signal; and e) providing the net conference signal to the participant.

Other aspects and features of the present invention will become apparent to those ordinarily skilled in the art upon review of the following description of specific embodiments of the invention in conjunction with the accompanying figures.

### BRIEF DESCRIPTION OF DRAWINGS

The present invention will be described in conjunction with the drawings in which:

FIG. 1 is a schematic representation of a prior art centralized conference bridge.

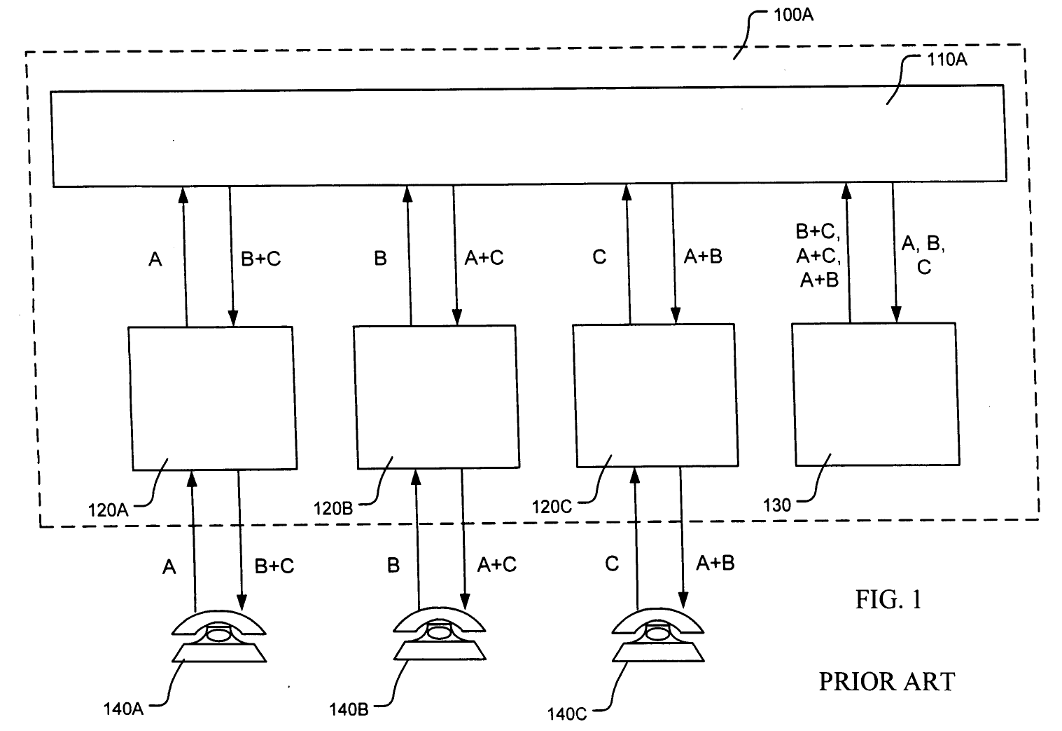

FIG. 2 is a schematic representation of a prior art centralized conference bridge with an auxiliary chassis.

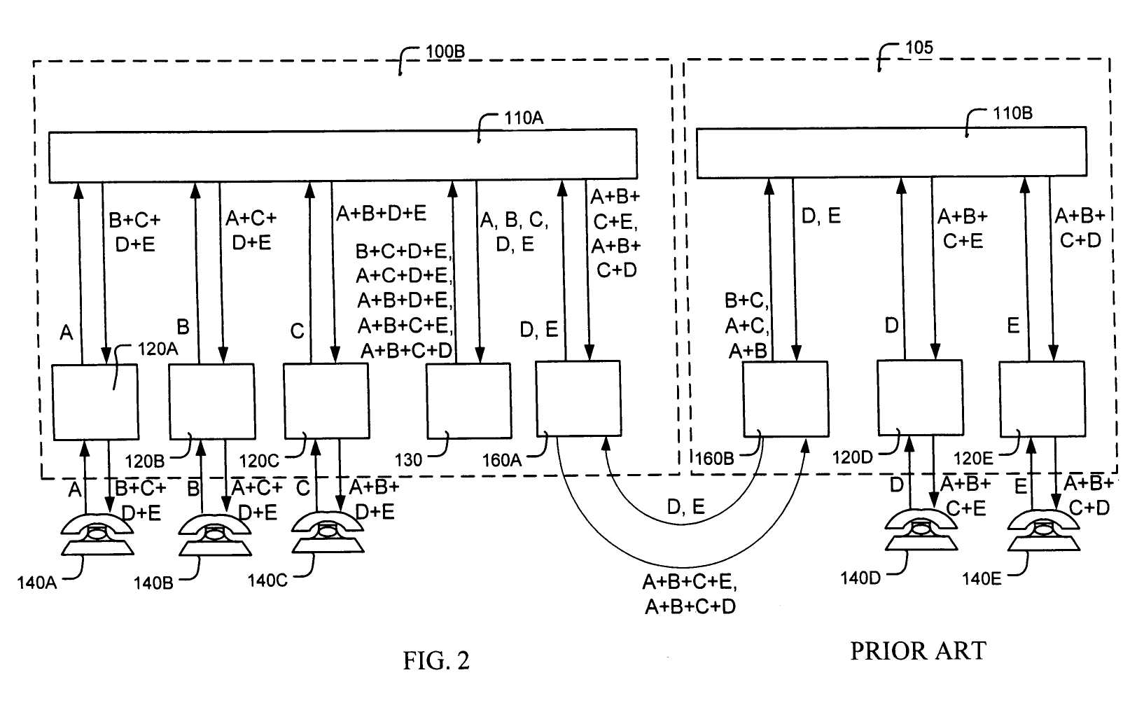

FIG. 3 is a schematic representation of an exemplary embodiment of a conference bridge of the present invention.

FIG. 4 is a schematic representation of an exemplary embodiment of an interface module of the present invention.

FIG. 5 is a schematic representation of another exemplary embodiment of a conference bridge of the present invention having two participants connected to one interface module.

FIG. 6 is a schematic representation of yet another exemplary embodiment of a conference bridge of the present invention having two buses.

FIG. 7 is flow diagram representing the steps in a method for operation of a distributed conference bridge according to the present invention.

### DETAILED DESCRIPTION

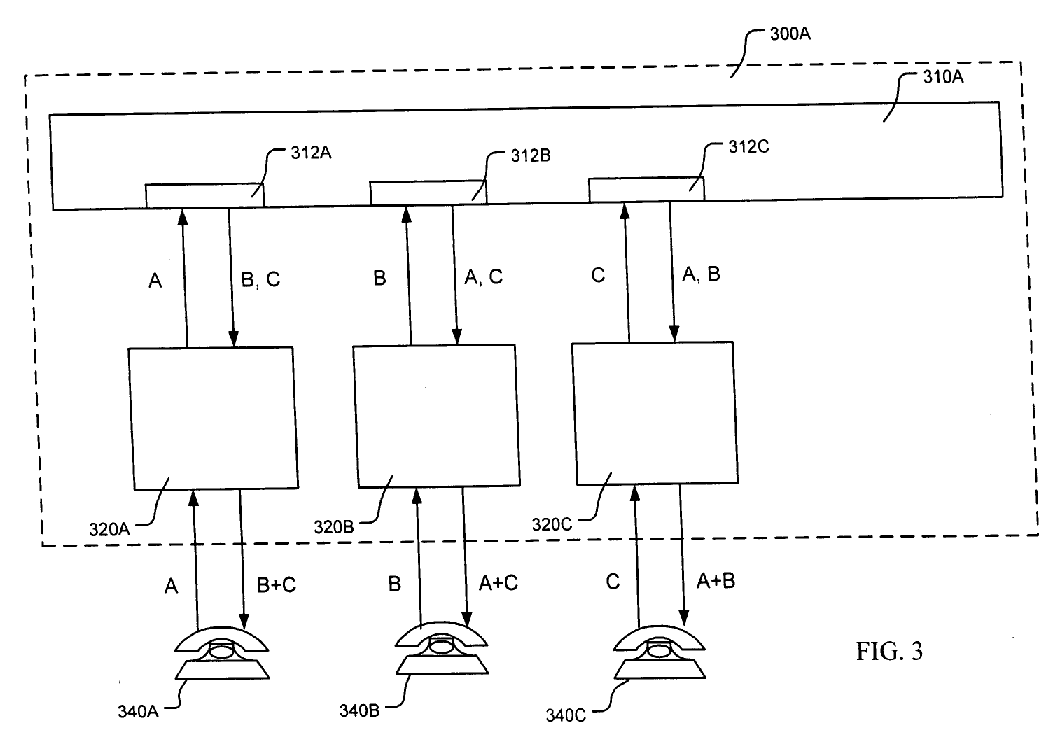

The conference bridge of the present invention takes a distributed approach to the implementation of the conferencing function. Rather than rely on a centralized conference bridge, conference bridge capabilities are implemented on each of the interface cards. In FIGS. 3-6 the arrows connecting the elements indicate the flow of signals. The annotations beside the arrows identify exemplary signals in a conference call scenario.

FIG. 3 represents a schematic view of an exemplary embodiment of a distributed conference bridge 300A of the present invention for enabling a telephony conference call having multiple participants. The distributed conference bridge 300A is comprised of a bus 310A and a plurality of interface modules 320A-C. Although three interface modules 320A-C are shown for illustrative purposes in this embodiment, any positive number (including 1) of interlace modules may be used while remaining within the spirit and scope of the present invention. The bus 310A has a plurality of ports to which devices, such as interlace modules 3201A-C, can connect. A device connected to one of the ports can provide, to the bus 310A, a signal, in particular a voice signal, which in turn is provided by the bus to devices connected to the other ports. The bus distributes (i.e. provides) a signal received from one connected device to all other connected devices.

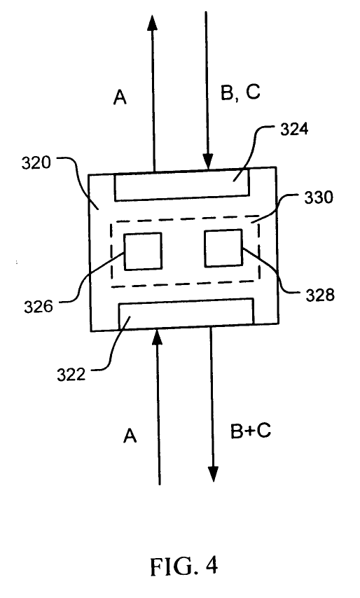

Although the specific embodiment of each interface module 320A-C does not need to be identical, each of the interface modules 320A-C does comprise specific features. FIG. 4 represents an exemplary interface module 320A (however this example can apply equally to any of the other interface modules 320B-C) having a line interface 322, a bus interface 324 and a signal bridging mechanism 330 comprising a summing mechanism 326 and a subtracting mechanism 328. The line interface 322 serves to receive, for example, a participant voice signal A and to provide a net conference voice signal B+C. The line interface 322 is connected to a terminal device (e.g. a telephone handset) used by a participant in the conference call. The connection from the line interface 322 to the terminal device can be substantially direct (e.g. the line interface 322 terminates a standard plain-old telephone service—POTS—access line) or indirect (e.g. the interference terminates a voice channel on a time division multiplex—TDM—trunk or a packet switching circuit.) The connection from the line interface 322 to the terminal device call use any of the well known voice communications techniques such as, for example, POTS, Pulse Code Modulation (PCM), TDM, voice over Internet Protocol (VoIP), voice over ATM, or other similar voice communications techniques. The connection from the line interface 322 to the terminal device is preferentially bi-directional, but in some configurations of the conference call the connection can be uni-directional—either send only (providing the participant voice signal) or receive only (receiving the net conference signal). In the case of a bi-directional connection, the line interface 322 receives, from the terminal device, the participant voice signal, for example A, and provides, to the terminal device, the net conference voice signal, for example B+C. The participant voice signal represents the sounds uttered by the conference call participant. The net conference voice signal represents the combined utterances of other participants in the conference call.

The bus interlace 324 provides for the connection of the interface module 320 to a port of the bus 310A. The bus interface 324 enables the interface module 320 to provide the participant voice signal A via the port to the bus 324. The bus interface 324 also enables the interface module 320 to receive from the port a plurality of signals, for example B, C. These signals represent participant voice signals B, C provided to the bus 310A by other interlace modules 320B and 320C respectively.

The summing mechanism 326 sums the plurality of signals received from the port B, C and the participant voice signal A to generate a total conference voice signal A+B+C. The summing mechanism 326 call use any of the well-known techniques for summing (also known as adding or mixing) voice signals. The subtracting mechanism 328 subtracts from the total conference voice signal A+B+C the participant voice signal A to generate the net conference voice signal B+C. Subtracting of the participant voice signal results in the mitigation of the ‘echo’ effect in the net conference voice signal that is provided to the terminal device (i.e. to the participant.) The subtracting mechanism 328 can use any of the well-known techniques for subtracting voice signals. See the description of implementation technologies and techniques below for more details. It will be understood that the summing mechanism 326 and the subtracting mechanism 328 can, but need not, share a common implementation.

In an alternative embodiment (not illustrated) the signal bridging mechanism 330 comprises a summing mechanism 326 but not a subtracting mechanism 328. In this alternative embodiment the summing mechanism 326 sums the plurality of signals received from the port B, C to generate a net conference voice signal B+C.

Referring again to FIG. 3 the bus 310A has a plurality of ports 312A-C to which the interface modules 320A-C can connect respectively. Interface module 320A, for example, provides a signal A to the bus 310A via the port 312A. The bus distributes the signal A to the other ports 312B, 312C and provides the signal A to the other interface modules 320B, 320C connected to these other ports. Similarly, interface module 320B can provide a signal B to port 312B that is distributed by the bus 310A to interface modules 320A, 320C via ports 312A, 312C respectively and interface module 320C can provide a signal C to port 312C that is distributed by the bus 310A to interface module 320A, 320B via ports 312A, 312B respectively.

In the case of a listen only participants, for example the participant associated with terminal device 340A, there is no participant voice signal A. No participant voice signal is provided to the bus 310A or alternatively a null signal is provided for voice signal A. As there is no participant voice signal, the summing mechanism 326 does not add in the participant voice signal or alternatively adds a null signal to generate a total conference signal B+C. Similarly the subtracting mechanism 328 effectively performs a null operation, the net conference signal B+C being the same as the total conference signal B+C. For the alternative embodiment described previously in which the signal bridging mechanism 330 comprises a summing mechanism 326 but not a subtracting mechanism 328, operation of the summing mechanism 326 remains the same in the case of a listen only participant.

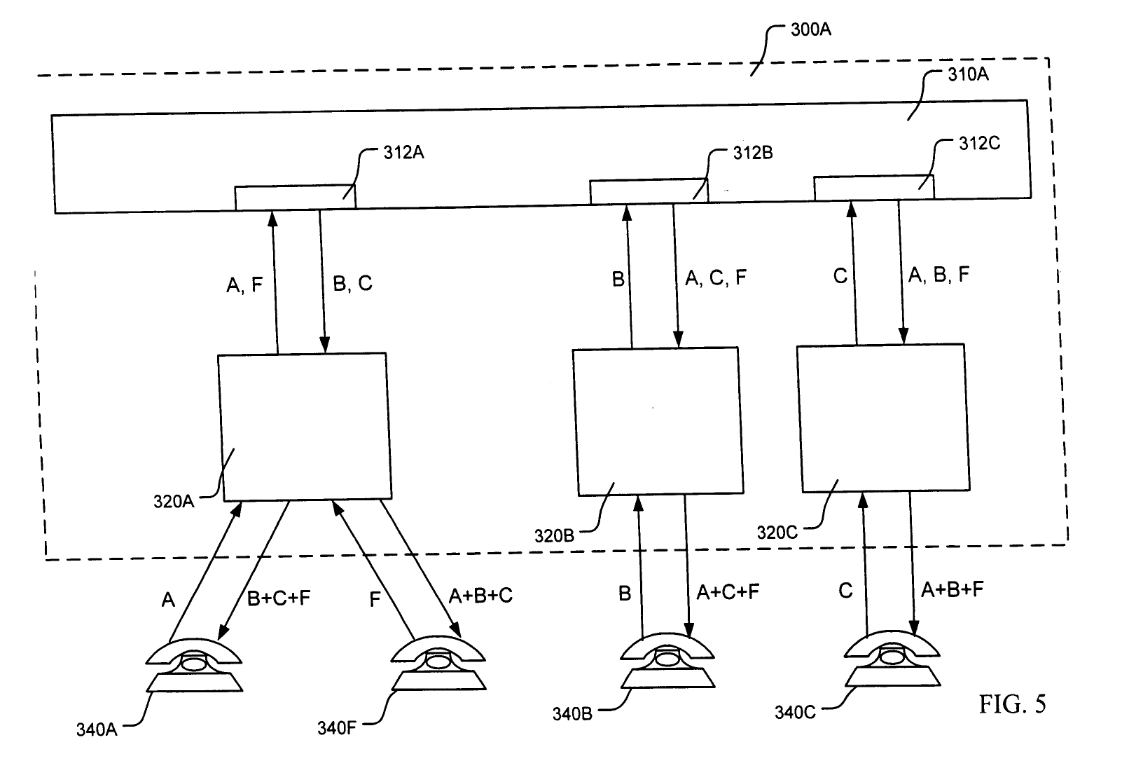

Referring now to FIG. 5, the conferencing bridge 300A is the same as that in FIG. 3 but in this case an interface module, for example 320A, is connected to two terminal devices 340A, 340F. In this way the interface module 320A can support two conference call participants. The interface module 320A can connect to any positive number of terminal devices (thereby supporting a corresponding number of participants) while remaining within the scope and spirit of the present invention. Each of the connected terminal devices can be of a different type (e.g. POTS handset, cellular phone, Internet Protocol phone, etc.) and as described above can be connected using any of the well-known voice communications techniques. Operation of the embodiment in FIG. 5 is similar to that described with reference to FIGS. 3 and 4. In this case, the interface module receives a voice signal F from terminal device 340F in addition to receiving voice signal A from terminal device 340A. Both voice signals A, F are provided to the bus 310A. The bus 310A distributes the signals A, F as described above. As with the configuration of FIG. 3, the interface module 340A receives from the bus 310A the voice signals B, C. The summing mechanism 326 sums the voice signals A, B, C, F to generate a total conference signal A+B+C+F. The subtracting mechanism 328 generates two net conference signals. One by subtracting voice signal A from the total conference signal A+B+C+F thus generating the net conference signal B+C+F that is sent to terminal device 340A. The other by subtracting voice signal F from the total conference signal A+13+C+F thus generating the net conference signal A+B+C that is sent to the terminal device 340F. Operation for the other interface modules 320B, 320C will be the same as in the configuration of FIG. 3 with the addition that voice signal F is received from the bus 310A and is included in the total conference signals and net conference signals as appropriate. In the alternative embodiment described previously in which the signal bridging mechanism 330 comprises a summing mechanism 326 but not a subtracting mechanism 328, the summing mechanism 326 generates the two net conference signals in this scenario.

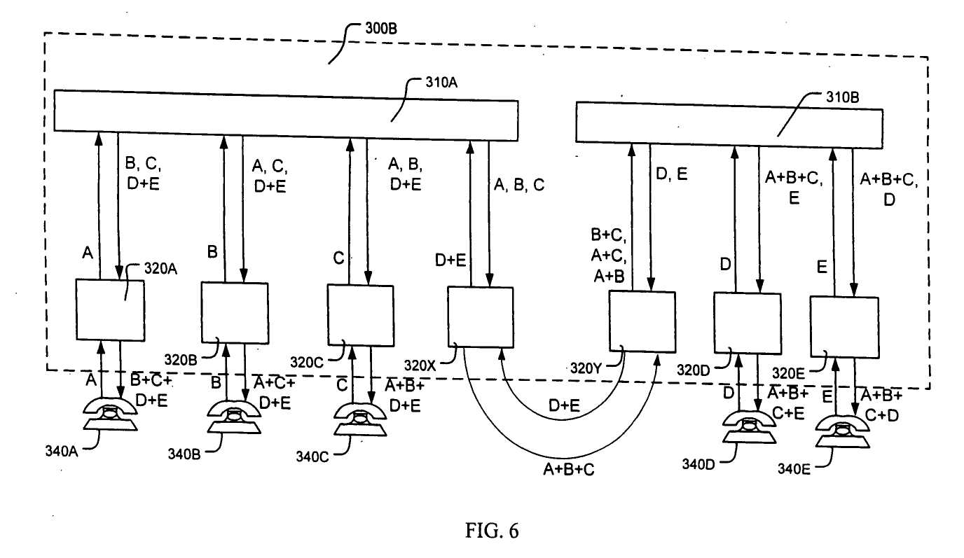

FIG. 6 represents all embodiment of the present invention in which some of conference call participants may be located relatively remotely from the other participants. The conference bridge 300B has a interface modules 320A-C connected to a bus 310A similar to those in FIG. 3. In addition, an inter-bus interface module 320X is also connected to bus 310A. Further interface modules 320D-F and an inter-bus interface module 320Y are connected to a second bus 310B. Inter-bus interface modules 320X, 320Y can be connected such that inter-bus interface module 320X can send a voice signal that will be received by inter-bus interface module 320Y and inter-bus interface module 320Y can send a voice signal that will be received by inter-bus interface module 320X. The connection between the inter-bus interface modules 320X, 320Y can be by any of the well-known telephony techniques that support voice signals. Interface modules 320A-C, 320D-E are connected to terminal devices 340A-C, 340D-E respectively. Operation of interface modules 320A-C, 320D-E is analogous to that of the interface module 320A described with reference to FIGS. 3 and 4. Operation of inter-bus interface modules 320X, 320Y is also similar with each inter-bus interface module taking the place of a terminal device for the other inter-bus interface module. Inter-bus interface modules 320X, 320Y have a structure as described with reference to FIG. 4 with the exception that the subtracting mechanism 328 may be deleted. Inter-bus interface module 320X receives signals A, B, C from bus 310A. A local conference signal A+B+C is generated by the summing mechanism 326. The local conference signal A+B+C is provided to inter-bus interface module 320Y that receives the local conference signal A+B+C in a manner similar to a participant voice signal received from a terminal device and provides the local conference signal A+B+C to the bus 310B. Bus 310B distributes the signal A+B+C in a manner similar to that described above for a participant voice signal received by bus 310A. Similarly, inter-bus interface module 320Y receives signals D, E from bus 310B, generates a local conference signal D+E, and provides D+E to inter-bus interface module 320X that provides D+E to bus 310A. Thus, the conference call provided to the participants associated with terminal devices 340A-E is essentially indistinguishable from one provide in an embodiment (not shown) where all of the terminal devices 340A-E are connected to conference bridge of the present invention with a single bus. Also, the connection between the two inter-bus interface modules 320X and 320Y requires only sufficient bandwidth for one voice signal in each direction. The specific configuration represented in FIG. 6 is for illustrative purposes only. More than two buses can to interconnected in this same way, with a pair of interface modules connecting each pair of buses, and each bus can support any positive number of interface modules while remaining within the scope and spirit of the present invention. Similarly, any positive number of interface modules can be supported by the bus 310A of the embodiments according to FIGS. 3 and 5 while remaining within the scope and spirit of the present invention. The addition of an interface module provides an incremental means of increasing the ‘conference call’ capacity of the conference bridge of the present invention.

It will be understood that a conference call control mechanism is required to establish and to disestablish the conference call. The functions of the conference call control mechanism can include: detecting participants attempting to join the conference call; authenticating and/or authorizing participants to join the conference call; administering and applying participation policy (including: conference ownership, full-duplex participation listen-only participation, coach participation, and other similar policies); detecting participants leaving the conference call and releasing participants from the conference call. As a result of providing a sub-set or all of the above functions, the conference call control mechanism is capable of identifying which participants are participating in the conference call and determine (directly or indirectly) through which interface module each participant is connected. The identification of participants and the localization of the their connections to an interface modules can be communicated to each of the interface modules. The communications of this information can be via well-known means such as for example, signaling or messages sent via the bus 310A, over a separate communications and control channel between the conference call control mechanism such as for example via an Ethernet connection or other similar means. The conference call control mechanism and communications with the conference bridge can be according to the co-pending U.S. patent application Ser. No. 09/703,789, filed Nov. 2, 2000 by the present inventor, which is incorporated herein by reference, or according to other well-known conference control and communications means.

Implementation of the embodiments of the present invention according the FIGS. 3-6 and the corresponding descriptions can be based on a variety of well-known telephony technologies and techniques. For example the various voice signals described can be in pulse code modulated format (PCM) as is commonly used with voice encoder/decoders (CODEC). The PCM encoded signals can incorporate A-law or μ-law compression. In the case where compression is applied to the PCM encoded signals, the operations of the summing mechanism 326 and the subtracting mechanism 328 may be applied directly to the compressed signals without the need for decompression and recompression. The various operations on the signals provided by the interface modules 320A-E,X-Y can be implemented, for example, using a digital signal processor (DSP) and cooperating memory or other similar signal processing technologies. The summing mechanism 326 can use, for example, the partial sum technique in which the signals to be summed are added, one by one, to a partial sum accumulator memory. The DSP can operated according to a data-driven methodology in which instructions for the DSP are stored in memory, for example, in the form of a call control list. The summing mechanism 326 and the subtracting mechanism 328 can use pre-calculated addition and subtraction tables or a arithmetic processing unit such as one built into a DSP. The buses 310A,B can use a time-slot interchange technique such as time-division multiplexing (TDM) as specified in, for example, the Enterprise Computer Telephony Forum (ECTF) H.110 Bus Standard, 1997.

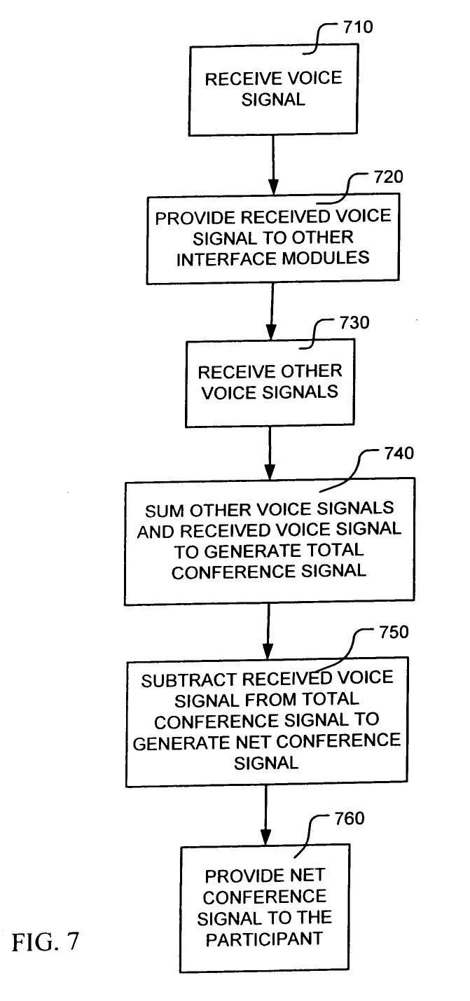

FIG. 7 represents the steps in a method for operation of a distributed conference bridge according to the present invention. The conference bridge is an apparatus such as the conference bridge 300A of FIG. 3 having a plurality of interface modules 320A-C according to FIGS. 3 and 4, each receiving a voice signal from and providing a net conference signal to a participant from a plurality of conference call participants. The method steps that occur concurrently for each of the plurality of interface modules are described as follows. Receiving a voice signal from the participant 710. Providing the received voice signal to each of the others of the plurality of interface modules 720. Receiving a plurality of other voice signals 730. These voice signals being the voice signals provided tin step 720 by the others of the plurality of interface modules and any voice signals from other participants received directly on the instant interface module. Summing together the plurality of other voice signals and the received voice signal to generate a total conference signal 740. Subtracting from the total conference signal the received voice signal to generate a net conference signal 750. Providing the net conference signal to the participant 760. Note that in the case of a listen only participant, the steps 710, 720 and 750 can be implemented as null operations as there is no received voice signal in that case. Also, where the conference bridge is an alternative embodiment as described earlier in which the signal bridging mechanism 330 comprises a summing mechanism 326 but not a subtracting mechanism 328, steps 740 and 750 can be simplified to a single step of summing together the plurality of other voice signals to generate a net conference signal.

The conference bridge and the associated method of the present invention have been described above in the context of a single conference call. It is to be noted that a single conference bridge can support multiple concurrent conference calls according to the apparatus and method of the present invention. The interface modules and the bus can be shared by (i.e. participate in) multiple concurrent conference calls while remaining within the spirit and scope of the present invention. Each conference call can be defined by the association of a plurality of terminal devices connected by a ‘virtual’ conference bridge comprising the sub-set of interface module and bus capacity required to enable the instant conference call. It is to be further noted that the conference bridge of the present invention need not be a dedicated implementation but instead may comprise features and capabilities incorporated in an apparatus, such as a telephony switching matrix, which is capable of delivering these and other telephony related features and capabilities. Those skilled in the art will recognize that a distributed conference bridge according to the present invention will provide greater robustness and tolerance (and therefore increased reliability) with respect to some failure and congestion modes compared to known centralized conference bridges, in particular to single point of failure and single point of congestion modes.

It will be apparent to one skilled in the art that numerous modifications and departures from the specific embodiments described herein may be made without departing from the spirit and scope of the present invention.

1. A distributed conference bridge comprising:
a bus, having a plurality of ports, for providing a signal received at one of said plurality of ports to all other of said plurality of ports; and
a plurality of interface modules, each for connecting to said bus via one of said plurality of ports, each having:
a line interface for receiving a participant voice signal and for providing a net conference voice signal;
a bus interface for providing said participant voice signal to said bus and for receiving, from said bus other participant voice signals; and
a signal bridging mechanism for generating said net conference voice signal from said other participant voice signals.

2. The distributed conference bridge of claim 1, said signal bridging mechanism comprising:
summing means for summing together said other participant voice signals and said participant voice signal to generate a total conference voice signal; and
subtracting means for subtracting from said total conference voice signal said participant voice signal to generate said net conference voice signal.

3. The distributed conference bridge of claim 1, said signal bridging mechanism comprising summing means for summing together said other participant voice signals to generate said net conference voice signal.

4. The distributed conference bridge of claim 1, wherein the bus and the plurality of interface modules are incorporated in a telephony switching matrix.

5. The distributed conference bridge of claim 2, wherein:
the line interface further includes means for receiving a second participant voice signal and for providing a second net conference signal;
the bus interface further includes means for providing said second participant voice signal;
the summing means further includes means for summing together the second voice signal with said other participant voice signals and said participant voice signal to generate the total conference signal; and
subtracting means further includes means for subtracting from said total conference signal said second participant voice signal to generate said second net conference signal.

6. The distributed conference bridge of claim 3, wherein:
the line interface further includes means for receiving a second participant voice signal and for providing a second net conference signal;
the bus interface further includes means for providing said second participant voice signal;
the summing means further includes:
means for summing together said second voice signal with said other participant voice signals to generate said net conference signal; and
means for summing together said participant voice signal with said other participant voice signals to generate said second net conference signal.

7. The distributed conference bridge of claim 1, further comprising:
a second bus, according to said bus;
a second plurality of interface modules, according to said plurality of interface modules, each for connecting to said second bus via one of said plurality of ports;
a first and a second inter-bus interface module for connecting to said bus and said second bus respectively, each via one of said plurality of ports, each having:
a line interface for receiving a participant voice signal and for providing a local conference voice signal;
a bus interface for providing said participant voice signal to said bus and for receiving from said bus other participant voice signals; and
summing for summing together said other participant voice signals to generate said local conference voice signal;
whereby said first inter-bus interface module is adapted to providing said local conference voice signal to said second inter-bus interface module as said participant voice signal and said second inter-bus interface module is adapted to providing said local conference voice signal to said first inter-bus interface module as said participant voice signal.

8. An interface nodule for use in a distributed conference bridge comprising a bus, having a plurality of ports, for providing a voice signal received at one of said plurality of ports to all other of said plurality of ports and a plurality of interface modules, according to said interface module and including said interface module, each for connecting to said bus via one of said plurality of ports, said interface module comprising:
a line interface for receiving a participant voice signal and for providing a net conference voice signal;
a bus interface for providing said participant voice signal to said bus and for receiving from said bus other participant voice signals; and
a signal bridging mechanism for generating said net conference voice signal from said other participant voice signals.

9. The interface module of claim 8, the signal bridging mechanism comprising:
summing means for summing together said other participant voice signals and said participant voice signal to generate a total conference voice signal; and
subtracting means for subtracting from said total conference voice signal said participant voice signal to generate said net conference voice signal.

10. The interface module of claim 8, the signal bridging mechanism comprising summing means for summing together said other participant voice signals to generate said net conference voice signal.

11. A method for operation of a distributed conference bridge having a plurality of interface modules each receiving a voice signal from and providing a net conference signal to a participant from a plurality of conference call participants, for each of the interface modules the method comprising the steps of:
a) receiving the voice signal from the participant;
b) providing, the voice signal to each of the others of the plurality of interface modules;
c) receiving a plurality of voice signals provided in step b) by the others of the plurality of interface modules;
d) summing together the voice signal and the plurality of voice signals to generate a total voice signal;
e) subtracting the voice signal from the total voice signal to generate a net conference signal; and
f) providing the net conference signal to the participant.

12. A computer program product for operation of a distributed conference bridge having a plurality of interface modules each receiving a voice signal from and providing a net conference signal to a participant from a plurality of conference call participants, the computer program product comprising:
computer readable program code devices for:
a) receiving, the voice signal from the participant;
b) providing the voice signal to each of the others of the plurality of interface modules;
c) receiving plurality of voice signals provided in step b) by the others of the plurality of interface modules;
d) summing together the voice signal and the plurality of voice signals to generate a total voice signal;
e) subtracting the voice signal from the total voice signal to generate a net conference signal; and
f) providing the net conference signal to the participant.

13. A method for operation of a distributed conference bridge having a plurality of interface modules each receiving a voice signal from and providing a net conference signal to a participant from a plurality of conference call participants, for each of the interface modules the method comprising the steps of:
a) receiving the voice signal from the participant;
b) providing the voice signal to each of the others of the plurality of interface modules;
c) receiving a plurality of voice signals provided in step b) by the others of the plurality of interface modules;
d) summing together the plurality of voice signals to generate a net voice signal; and
e) providing the net conference signal to the participant.

14. A computer program product for operation of a distributed conference bridge having a plurality of interface modules each receiving a voice signal from and providing a net conference signal to a participant from a plurality of conference call participants, the computer program product comprising:
computer readable program code devices for:
a) receiving the voice signal from the participant;
b) providing the voice signal to each of the others of the plurality of interface
c) receiving a plurality of voice signals provided in step b) by the others of the plurality of interface modules;
d) summing together the plurality of voice signals to generate a net voice signal; and
e) providing the net conference signal to the participant.
